(19) United States
(12) Patent Application Publication
(10) Pub. No.: US 2013/0032030 A1
(43) Pub. Date: Feb. 7, 2013

(54) EXHAUST AIR SYSTEM AND METHOD THEREFOR

(71) Applicants: Dirk Bareis, Donaueschingen (DE); Florian Kaltenbach, Schonwald (DE); André Lindert, Villingen (DE); Pasquale Roccia, Schonach (DE); Holger Sprenger, Gutenbach (DE)

(72) Inventors: Dirk Bareis, Donaueschingen (DE); Florian Kaltenbach, Schonwald (DE); André Lindert, Villingen (DE); Pasquale Roccia, Schonach (DE); Holger Sprenger, Gutenbach (DE)

(73) Assignee: RENA GmbH, Gutenbach (DE)

(21) Appl. No.: 13/552,500

(22) Filed: Jul. 18, 2012

(30) Foreign Application Priority Data
Aug. 5, 2011 (DE) 102011109568.7

(51) Int. Cl. B01D 19/00

(52) U.S. Cl. 95/263; 96/202

(57) ABSTRACT

An apparatus for the removal of gaseous reaction products (2) from an inline plant (1) for the single sided wet chemical treatment of flat objects (3) by means of a transport gas (G) has an entry (8), a treatment basin (4) for the reception of a treatment liquid (F), an inline transport device (5) with a transport plane (6) for the horizontal transport of the flat objects (3) in transport direction (7), an exit (9), as well as a collection chamber (10) for gaseous reaction products (2) which is arranged above the transport plane (6).

### CROSS-REFERENCE TO RELATED APPLICATIONS

This application claims benefit of priority to German patent application Ser. No. DE 10 2011 109 598.7, filed Aug. 5, 2011; the contents of which are herein incorporated by reference in its entirety.

### TECHNICAL FIELD

The invention relates to an apparatus and a method for the improved removal of air which is charged with reactive gases in the context of the chemical inline treatment of substrates.

### BACKGROUND OF THE INVENTION

From the state of the art, inline plants for the wet chemical treatment of flat objects are known. Such objects are for example silicon substrates as being used in the semiconductor and solar cell production. For certain process steps, merely a single sided wet chemical treatment of such substrates is desired. During this treatment, only one side of the substrate is subjected to a treatment, whereas the other side shall remain in the original state. Typically, such treatments take place in wet chemical plants, where the substrates are transported through the treatment liquid, or along its surface.

Various methods are known from the art for the single sided wet chemical treatment.

According to a first variant, the side which is not to be treated is protected with a protective layer which must be applied before the (wet chemical) process step, and which must usually be removed again after this process step. Here, the additional effort for the protective coating and removal is disadvantageous.

According to a secondary variant, the side which is not to be treated rests against a sealing counter surface; either with its entire surface, e.g. against a vacuum chuck, or at least in the border region, which can e.g. be formed by a sealing lip. So, no treatment liquid can reach the not to be treated side of the substrate during the wet chemical process step. The not insignificant technical effort, as well as the fact that the often touch sensitive substrate surface can be damaged or soiled by the protecting counter surface, are disadvantageous.

According to a further variant, the substrate which must be treated is guided in a manner along the surface of the treatment liquid, such that only its underside, and optionally its edges, come into contact with the treatment liquid. Such a treatment method is for example disclosed in document EP 1 733 418. As long as the transport through the treatment liquid takes place accordingly carefully, the top side of the substrate remains untreated, without the need for a protective layer or for the contact to a counter surface.

However, a problem consists in the gas bubbles which occur during the wet chemical treatment and which result from the chemical reaction, such as e.g. nitrogen oxides (NOₓ), which aggregate at the underside of the substrate, in order to eventually rise, when looking in transport direction, at the rear edge of the angular substrate or in the rear region of the circular substrate, to the liquid surface, where they eventually burst. Upon bursting of the gas bubbles, fine droplets can form which contaminate in an undesired manner the substrates' top side, and there particularly the rearwards pointing region, thus negatively influencing the treatment result. Further, the (unprotected) substrate top side is subjected to these as well as optionally to further reactive gases, which can also result in undesired modifications of this side.

Subsequently, the reaction gases aggregate in the region above the treatment liquid and the substrates. Therefore, such inline plants typically provide an exhaust of the reaction gases. The exhaust in known plants always takes place directly vertically upwards; typically through a protective grating. In order to achieve quick exhausting of the reaction gases, the exhaust usually operates under full load. As a result, a further increase of the power of the exhaust is not possible. The protective grating represents an additional fluidic resistance, which further reduces the volumetric yield of the exhaust. However, a further increase of the input power is not economic, so that despite the exhaust, the concentration of undesired gaseous reaction products remains high.

A further problem regarding such exhausts consists in the fact that waves can form at the surface of the treatment liquid which can result in the wetting of the top side of a substrate. Furthermore, an upwards directed too strong suction can result in lifting of the substrates, which must be avoided under all circumstances. Also, it cannot completely be excluded that the vertical suction throws the liquid droplets which form during bursting of the gas bubbles onto the top side of the substrates.

### BRIEF SUMMARY OF THE INVENTION

The object of the invention therefore consists in providing an apparatus and a method which allow for a single sided wet chemical treatment of flat objects such as e.g. silicon substrates while exhausting the developing reaction gases, wherein the mentioned issue of undesired wetting of the top side due to bursting gas bubbles is avoided, without the need for a protection of this side.

This shall be achieved without a further increase of the input power.

The invention shall further be suitable to modify existing apparatuses in a simple and cost-effective manner in order to meet the problem of insufficient exhaust.

The object is solved in one aspect by an apparatus for the removal of gaseous reaction products from an inline plant for the single sided wet chemical treatment of flat objects by means of a transport gas, having an entry, a treatment basin for the reception of a treatment liquid, an inline transport device with a transport plane for the horizontal transport of the flat objects in transport direction, an exit, as well as a collection chamber for gaseous reaction products which is arranged above the transport plane, characterized in that the collection chamber, upon forming an exhaust air channel, provides an inlet opening in the region of the exit and an outlet opening in the region of the entry in such a manner that the transport gas can flow through the exhaust air channel contrary to the transport direction as well as essentially parallel to the transport plane and to the transport direction.

A second aspect of the invention provides a method for the removal of gaseous reaction products from an inline plant for the single sided wet chemical treatment of flat objects by means of a transport gas, using the apparatus, characterized in that the transport gas in the exhaust air channel is guided contrary to the transport direction and essentially parallel both to the transport plane and the transport direction.

Further preferred embodiments are provided in the detailed discussion as well as the figures.

### BRIEF DESCRIPTION OF THE DRAWINGS

FIG. 1 is a schematic drawing showing an inline plant with an exhaust air device according to the state of the art.

FIG. 2 is a schematic drawing showing an inline plant with an apparatus according to the invention

FIG. 3 is a schematic showing the situation in the region of a single flat object during performing the method according to the invention.

### DETAILED DESCRIPTION

In the following, firstly, the apparatus onto which the invention is based is described. Subsequently, the method according to the invention which can be carried out by such an apparatus is presented.

The apparatus according to the invention serves for the removal of gaseous reaction products from an inline plant which in turn is provided for the single sided wet chemical treatment of flat objects. The apparatus comprises an entry, a treatment basin for the reception of a treatment liquid which can e.g. be an etching or cleaning liquid; an inline transport device with a transport plane for the horizontal transport of the flat objects in a transport direction along a transport line, wherein for example rollers, belts, bands or rods come into question as transport device; an exit, through which the objects to be treated enter or leave the apparatus, respectively; as well as a collection chamber for gaseous reaction products which is arranged above the transport plane. The transport direction is defined by the direction from the entry to the exit. Typically, the collection chamber is limited at its sides by according walls, and upwards by a ceiling. According to the invention, the apparatus is characterized in that, upon forming an exhaust air channel, the collection chamber provides an inlet opening in the region of the exit and an outlet opening in the region of the entry in such a manner that the transport gas can flow through the exhaust air channel contrary to the transport direction.

In other words, the apparatus has an inlet opening in the region of the one end of the transport line, and an outlet opening in the region of the other end of the transport line, so that between fresh air entry and exhaust air exit an exhaust air channel is formed which comprises the collection chamber, and which can uniformly be flown through with the aforementioned transport gas in horizontal direction. Thus, the apparatus according to the invention differs from a known apparatus in that the exhaust air, i.e. the transport gas which is charged with gaseous reaction products, is not removed in vertical direction, but has at least one flow component that runs parallel to the transport plane.

The thus forming gas stream runs essentially horizontally, i.e. parallel to the transport plane, and furthermore parallel to the transport direction. A lifting of the substrates by a strong suction, or the generation of waves which could contaminate the substrate surface is effectively avoided. Since no fluidic obstacles are present on the way from fresh air entry to exhaust air exit, a lower power than the one which is necessary for vertically working apparatuses is sufficient.

The effect of avoiding the contamination is particularly achieved in that the fresh air entry is arranged in the region of the exit, and the exhaust air exit is arranged in the region of the entry, so that the exhaust air channel can be flowed through by transport gas from the exit to the entry of the apparatus. As a result, the flowing through of transport gas takes place contrary to the transport direction. The effect of the arrangement, according to the invention, of fresh air entry and exhaust air exit is that the above mentioned droplets which result from the gas bubbles that rise in the rear region of a substrate and burst there, are being transported away from the surface of a substrate. Therefore, the fine mist of droplets cannot reach onto the surface of that substrate from whose rear edge the droplet generating gas bubble was rising.

It is clear that the distance to a preceding substrate must be sufficiently large in order to avoid a contamination of the subsequent substrate by droplets which were formed at the rear edge of the preceding one.

It is preferred, that the inlet opening is formed by the exit, and/or the outlet opening is formed by the (substrate-)entry of the apparatus. In this way, a particularly simple construction of the apparatus is achieved.

Alternatively, special openings in the region of the entry and the exit can also be provided, through which the transport gas enters and leaves the apparatus. Such openings can for example be arranged directly above or laterally to the entry and/or the exit. In addition, pipes which suck in or emit the transport gas at another location are possible as well, as long as they begin or end at an according location in the region of the entry or the exit, respectively.

It is clear that an according gas conveying device for conveying the transport gas must be present or be functionally assigned to the apparatus. Accordingly, it is preferred that the apparatus according to the invention has a gas conveying device which is arranged in the region of the exhaust air channel and/or which is fluidically connected to the same. It is also clear that several of such gas conveying devices can be present which supply respective sub-segments of the apparatus according to the invention with fresh air, or which draw exhaust air from them, respectively. It is also possible to combine supply and exhaust devices. The device(es) can be arranged directly the collection chamber (e.g. as fans), or the transport gas is temporarily, and without significantly changing the horizontal flow as claimed according to the invention, guided through vertically or laterally leaving pipes, where it is accordingly accelerated.

According to a particularly preferred embodiment, the apparatus has a suction bell which is arranged in the region of the entry. The suction bell has suction bell openings of sufficient size into which the exhaust air is sucked in, and conveyed out of the apparatus. Particularly preferred, the suction bell openings are arranged in the region of the exhaust air channel (within the gas phase, horizontal suction). Alternatively, they are positioned above the exhaust air channel (above the gas phase, vertical suction).

According to another embodiment, the apparatus comprises means for influencing the flow velocity of the transport gas, i.e. the fresh and/or the exhaust air. Such means are preferably damper flaps or the like which alter the cross section of the components which supply fresh air and/or which draw exhaust air, so that the magnitude of the flow of exhaust air and the power change of the gas conveying device can be influenced in a suitable manner.

It is then particularly preferred that the apparatus also comprises a control unit for controlling the gas conveying device or the means for influencing the flow velocity, respectively. In this way, the change of the flow velocity can take place automatically as well.

According to a further embodiment, the apparatus according to the invention comprises means for the horizontal alignment of the flow of the transport gas. This means that the transport gas which possibly initially flows vertically, or from the sides, into the collection chamber can be deflected by means of blinds, baffles or the same in such a manner, that the flow as claimed according to the invention is formed. It is clear that analogously, the above mentioned can be valid as well for the flowing out of the transport class or the exhaust air, respectively.

Particularly preferred, one or several deflection bells are present for deflection of the fresh air that typically flows from above into the exhaust air channel, the deflection bells being located in the region of the (substrate-)exit, i.e. at the end of the transport line. For reasons of homogenization, air can be guided from a preferably perforated ceiling region (grating) into such a deflection bell. The transport gas eventually leaves the deflection bell in horizontal direction and therefore parallel to the transport plane and the flat objects which are transported in the latter, as well as contrary to the transport direction.

Particularly preferred, the area of the perforation is at least as large as the area of the opening(s) of the deflection bell(s). The area of these openings is preferably at least as large as the area of the aforementioned suction bell openings of the preferably present suction bell.

According to a further embodiment, at least one further inlet opening and/or outlet opening are arranged in the region of the collection chamber. This is always advantageous when the apparatus according to the invention is very long, or when a collection chamber comprises different treatment baths and therefore segments. It is then particularly preferred that each of these entries and/or exits is connected to a separate gas conveying device. In this manner, a sufficient transport velocity of the transport gas can always be ensured without providing extremely powerful gas conveying means, or it can be made sure that different reaction gases which develop in different segments of the inline plant are not mixed with each other. Also, different and easily-to-vary flow velocities and optionally flow directions can be generated in a simple manner, as long as the gas conveying means are accordingly flexibly controllable.

According to a particular preferred embodiment, the transport gas is air. Naturally, other gases are also possible, depending on the respective application. Cleaning or treating gases count thereto as well.

Furthermore, the preferred flow rate of transport gas, with respect to 1 m² cross sectional area of the exhaust air channel, is adjusted to 0.1 to 5 m³/min, and particularly preferred to 1 m³/min, and/or the component of the flow velocity pointing against (and parallel to) the transport direction amounts, in the region of the transport plane, to 0.01 to 5 m/s, and particularly preferred to 1 m/s.

The invention can also serve for the provision of a conversion kit for converting an apparatus as known from the art. Accordingly, such a conversion kit comprises stop plates for closing original exhaust air openings which were provided for vertical pass-through and which limit the collection chamber towards its top, as well as . a fresh air entry and/or exhaust air exit to be arranged in the region of the entry or the exit, wherein the fresh air entry has a fluidic connection to the outside, and the exhaust air exit has a fluidic connection to a gas conveying device. In other words, the conversion kit provides all essential components necessary to convert a common plant with vertical exhaust air suction into a plant according to the invention with horizontal flow through. It is clear that preferably, fresh air entry as well as exhaust air exit are being provided, and that the interconnection of the typically already present gas conveying device results in a flow through contrary to the transport direction. It is also clear that further above mentioned components, such as in particular means for the horizontal alignment of the flow of the transport gas, can be comprised by the described conversion kit.

According to a preferred embodiment of the described conversion kit, the stop plate which is to be arranged above the exhaust air exit (and only this plate) has a cutout to the original exhaust air opening which is located above. In this manner, it is ensured that the exhaust air is sucked off only at the end of the flow path which leads through the exhaust air chamber, and therefore at the entry of the converted inline plant, in (although) vertical direction, whereas it can flow in the remaining region of the collection chamber only horizontally, and as claimed according to the invention, since the originally present vertical openings are closed by the remaining stop plates.

As mentioned above, the invention relates also to a transport gas mediated method for the removal of gaseous reaction products from an inline plant for the single sided wet chemical treatment of flat objects.

Accordingly, the invention relates to a method for the removal of gaseous reaction products from an inline plant for the single sided wet chemical treatment of flat objects by means of a transport gas, using an apparatus as defined above, wherein the method is characterized in that the transport gas in the exhaust air channel is guided contrary to the transport direction and essentially parallel both to the transport plane and the transport direction.

In order to avoid repetitions, reference is made to the above explanations regarding the apparatus according to the invention.

Basically, the flow direction of the transport gas for the removal of the gaseous reaction products has one or several components which run parallel to the transport direction. Each vector of the flow at a location inside the collection chamber has one or several of these components, for example a vertical component, a component which points in transport direction, and a laterally oriented component which stands perpendicular on the other two components. Thus, the components preferably run along the axes of a rectangular coordinate system which corresponds to the according main directions of the inline plant. Now, according to the invention, the component which runs parallel to the transport plane and parallel to the transport direction may not be zero, and it must run contrary to the transport direction. That means that the flow is not exclusively composed of vertical components. For the case that the flow runs in segments, i.e. cannot have a path which is continuous from the entry to the exit and which is parallel to the transport plane, the respective components of the individual or segment flows must be analogously oriented in an according manner. The latter is particularly the case if the inline plant comprises several exhaust air segments which in turn respectively have, separately from each other, the flow components according to the invention. In the following, unless otherwise stated, the presence of one single exhaust air channel is assumed for the sake of simplicity.

According to a preferred embodiment, the flow direction of the transport gas has exclusively such components which run parallel to the transport plane. This means that the flow exclusively consists of horizontal components. Such components can for example run diagonally to the transport direction, i.e. (when looking in transport direction) from the left to the right, and/or vice versa.

According to another, particularly preferred embodiment, the flow direction of the transport gas has additionally exclusively such components which run parallel to the transport direction. This means that the flow exclusively consists of horizontal components which run in and/or contrary to the transport direction.

It is clear that a component which runs parallel to the transport plane must not imperatively run parallel to the transport direction as well. On the contrary, however, a component which runs parallel to the transport direction imperatively also runs parallel to the transport plane.

It is further preferred that these components run not only parallel to the transport plane, but also as far as possible parallel to the transport direction, i.e. between entry and exit of the inline plant.

It is particularly preferred that (at least most possibly) each/all component(s) is or are, respectively, oriented from exit to entry, and therefore contrary to the transport direction. It is clear that, for example in the region of the inlet opening and/or the outlet opening, it must be deviated from this direction for constructive reasons, without leaving the scope of the invention. Regarding said counter flow, this is particularly unproblematic in the entry region of the inline plant, because here, no gas bubbles are yet to expect since the treatment of the substrates has just begun.

It is also preferred that the transport gas has a flow which is generated by at least one gas conveying device, the same being arranged in the region of the exhaust air channel and/or being fluidically connected to the same, and/or which is oriented, i.e. deflected, by means for the horizontal alignment of the flow of the transport gas. The devices and means which are preferably to be used for this have already been described beforehand, which is why no repetition is necessary thereof.

According to a further embodiment, the degree or the intensity of the deflection depends on the flow velocity. This means that for low flow velocities, a more intense, more abrupt deflection is possible than for higher flow velocities which need a more gentle deflection with larger radii and streamlined shapes.

Low flow velocities lie in the range of 0.01 to 1 m/s, whereas high flow velocities can amount to 5 m/s and more.

According to a further embodiment, the velocity of the flow of the transport gas in the exhaust air channel is controlled depending on the concentration of gaseous reaction products carried off by the transport gas. Accordingly, a lower flow velocity is sufficient for lower concentrations. In this manner, it is possible to react most economically on the respective situation. Preferably, according sensors are provided which measure the level of contamination of the exhaust air and which pass it to the control unit, or to accordingly provided damper flaps, respectively, so that a requirement-driven control of the flow velocity becomes possible.

In the following, the invention is schematically described in a preferred embodiment by means of figures.

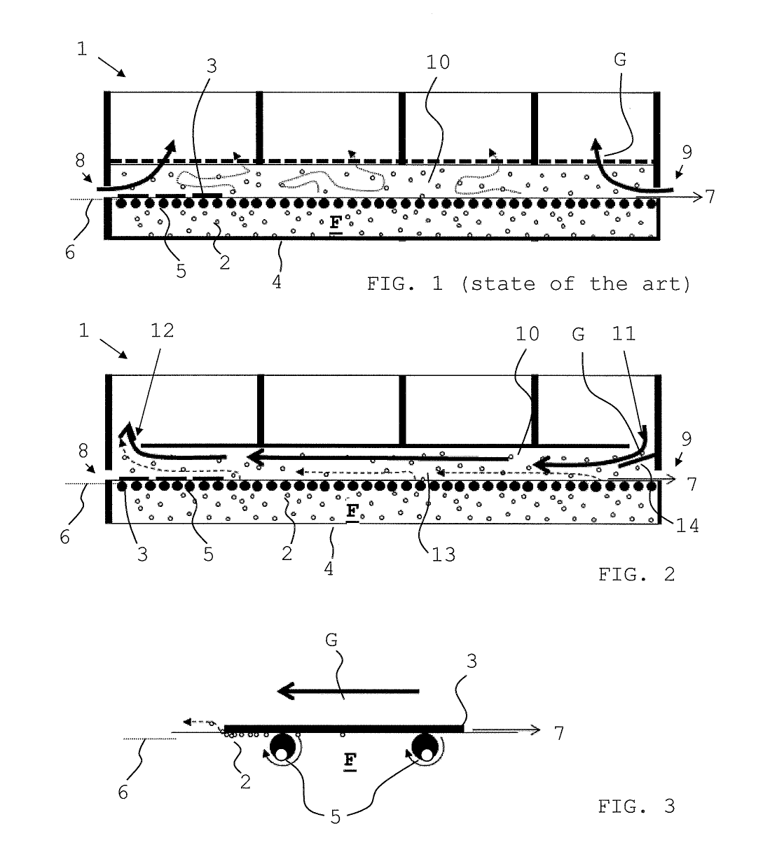

The apparatus as depicted in FIG. 1 gives a rough schematic representation of the construction of an exhaust air device of a known inline plant 1. The plant consists essentially of a treatment basin 4 which is filled with a treatment liquid F. At the surface of the treatment liquid F, flat objects 3, also called substrates here, are horizontally guided in transport direction 7 along on the transport plane 6. For this, and inline transport device 5 is used, which, in the depicted example, has a larger number of rollers which are sufficiently closely arranged one after another (shown in the picture as large, filled circles). The substrates 3 are treated only single sided because of their vertically precisely adjusted position, namely at their underside, by means of the treatment liquid F.

A collection chamber 10 is present above the treatment basin 4 which is filled with treatment liquid F. The collection chamber 10 is separated by means of a grating from an exhaust air chamber which is located above the collection chamber 10. The substrates 3 enter the collection chamber 10 through an entry 8, and leave it through an exit 9. The collection chamber 10 serves for the collecting of gaseous reaction products 2 (depicted in all figures as small, not filled circles). These reaction products 2 form during the chemical treatment in particular at the underside of the substrates 3, emerge from the treatment liquid F and must be transported away in order to avoid an undesired treatment of the substrate top sides. For this, a transport gas G, ambient air in this case, is sucked in through the entry 8 and the exit 9. The transport gas G takes the reaction products 2 with it on its way through the grating which limits the collecting chamber 10 in upward direction. The flow of the transport gas G is represented by the thick, continuously drawn arrows. Some of the flow paths of the reaction products 2 are represented by the thin, punctuated arrows. As can be derived from FIG. 1, these paths do not run on the shortest way to the surface of the treatment liquid F towards the grating and through the same, but they firstly drift in an uncontrolled manner through the collection chamber 10, until they are close enough to the grating. The reason for this lies in the too low vertical flow of the transport gas G in the central region of the collection chamber 10. Therefore, particularly in the central region, the increased danger exists of an undesired treatment of the substrate top sides by means of the gaseous reaction products 2. Furthermore, forming droplets splash in an uncontrolled manner in all directions (not depicted) when the reaction products 2 break through the surface of the treatment liquid F. Thus, a danger of a contamination of the substrate surfaces exists as well.

These problems are effectively avoided by the apparatus according to the invention according to FIG. 2. The apparatus has an inlet opening 11 in the region of the one end of the transport line (exit 9), and an outlet opening 12 in the region of the other end (entry 8) of the transport line, so that an exhaust air channel 13 is formed between inlet opening 11 and exit opening 12 which comprises a collection chamber 10, and through which the transport gas G can flow contrary to the transport direction 7.

In order to ensure that the transport gas G which flows into the collection chamber 10 in the region of the exit 9 has most possibly no vertical component, a means for the horizontal alignment 14 of the flow of transport gas G is present there, which in this case is designed as baffle plate.

Since the exhaust channel 13 has an outlet opening 12 not before its end which, in the present case, is arranged in the region of the entry 8 of the inline plant 1, the transport gas G flows essentially horizontally through the collection chamber 10. From this results the following advantages.

The stream flows everywhere in the collection chamber 10 with the same velocity and intensity. An inhomogeneous removal, as it is the case for known plants, must not be expected.

Since no grating or the like obstructs the flow of the transport gas G, the gas conveying device (not depicted) can be dimensioned accordingly smaller, or it typically has, for a given size, a power reserve.

The contamination of the substrate top sides by means of splashes is avoided because of the flow of the transport gas G which runs contrary to the transport direction 7.

This is shown in FIG. 3. The transport direction 7 runs in the picture from the left to the right, since the rollers of the inline transport device 5 rotate clockwise, as indicated by the rotation arrows. The vertical position of the substrate 3 is precisely adjusted such that only its underside comes into contact with the treatment liquid F. Moreover, a comparable treatment result would also be achievable when (according to a non-depicted variant) the treatment liquid F would be taken up by the rollers 5 and “indirectly” be transferred onto the substrate 3 which would be positioned slightly higher than shown in the figure.

As summarized above, the flow direction of the transport gas G has a component which points contrary to the transport direction 7, for the removal of the gaseous reaction products 2. It even has primarily such components which run parallel to the transport plane 6. Exceptions are the region of the fresh air entry 11, as well as the exhaust air exit 12, where the flow increasingly has, for constructional reasons, vertical components as well.

As can be seen, gaseous reaction products 2 which accumulate at the underside of the substrate 3 rise up in the region of its rear edge (on the left in the picture). Because of the flow of the transport gas G, indicated by the thick, continuously drawn arrow, splashes which form during bursting of the gas bubbles are transported away from the rear edge and the surface of the substrate 3 (to the left in the picture). As a result, a contamination of the substrate top side must not be worried about. The apparatus and method according to the invention differ in this significantly from the apparatuses and methods known from the art.

The invention provides in an advantageous manner an apparatus and a method which allow for a single sided, wet chemical treatment of flat objects such as e.g. silicon substrates while exhausting the developing reaction gases, wherein the aforementioned problem of the undesired wetting of the top side due to bursting gas bubbles is avoided, without protection of the side being necessary. One embodiment allows a modification of existing apparatuses in a simple and cost-effective manner.

### LIST OF REFERENCES

1 inline plant
2 gaseous reaction product
3 flat object, substrate
4 treatment basin
5 inline transport device, rollers
6 transport plane
7 transport direction
8 entry
9 exit
10 collection chamber
11 fresh air entry, inlet opening
12 exhaust air exit, outlet opening
13 exhaust air channel
14 means for the horizontal alignment
F treatment liquid
G transport gas Amendments to the Claims

1. An apparatus for the removal of gaseous reaction products (2) from an inline plant (1) for the single sided wet chemical treatment of flat objects (3) by means of a transport gas (G), having an entry (8), a treatment basin (4) for the reception of a treatment liquid (F), an inline transport device (5) with a transport plane (6) for the horizontal transport of the flat objects (3) in transport direction (7), an exit (9), as well as a collection chamber (10) for gaseous reaction products (2) which is arranged above the transport plane (6), characterized in that the collection chamber (10), upon forming an exhaust air channel (13), provides an inlet opening (11) in the region of the exit (9) and an outlet opening (12) in the region of the entry (8) in such a manner that the transport gas (G) can flow through the exhaust air channel (13) contrary to the transport direction (7) as well as essentially parallel to the transport plane (6) and to the transport direction (7).

2. The apparatus according to claim 1, wherein the inlet opening (11) is formed by the exit (9), and/or the outlet opening (12) is formed by the entry (8) of the apparatus.

3. The apparatus according to claim 1, further comprising a gas conveying device which is arranged in the region of the exhaust air channel (13) and/or which is fluidically connected to the same, and/or means for influencing the flow velocity of the transport gas (G).

4. The apparatus according to claim 3, further comprising a control unit for controlling the gas conveying device and/or the means for influencing the flow velocity.

5. The apparatus according to claim 1, further comprising means for the horizontal alignment (14) of the flow of the transport gas (G).

6. The apparatus according to claim 1, wherein at least one further inlet opening and/or outlet opening are arranged in the region of the collection chamber (10).

7. The apparatus according to claim 1, wherein the transport gas (G) is air, and/or the flow rate, with respect to 1 m² cross sectional area of the exhaust air channel (13) is adjusted to 0.1 to 5 m³/min, preferably to 1 m³/min, and/or wherein the component of the flow velocity pointing against the transport direction (7) amounts in the region of the transport plane (6) to 0.01 to 5 m/s, preferably to 1 m/s.

8. A method for the removal of gaseous reaction products (2) from an inline plant (1) for the single sided wet chemical treatment of flat objects (3) by means of a transport gas (G), using an apparatus as defined in claim 1, characterized in that the transport gas (G) in the exhaust air channel (13) is guided contrary to the transport direction (7) and essentially parallel both to the transport plane (6) and the transport direction (7).

9. The method according to claim 8, wherein the apparatus has an entry (8), a treatment basin (4) for the reception of a treatment liquid (F), an inline transport device (5) with a transport plane (6) for the horizontal transport of the flat objects (3) in transport direction (7), an exit (9), as well as a collection chamber (10) for gaseous reaction products (2) which is arranged above the transport plane (6), and wherein the collection chamber (10), upon forming an exhaust air channel (13), has an inlet opening (11) in the region of the exit (9) and an outlet opening (12) in the region of the entry (8).

10. The method according to claim 8, wherein the transport gas (G) has a flow which is generated by at least one gas conveying device which is arranged in the region of the exhaust air channel (13) and/or which is fluidically connected to the same, and/or which is deflected by means for the horizontal alignment (14) of the flow of the transport gas (G).

11. The method according to claim 8, wherein the velocity of the flow of the transport gas (G) in the exhaust air channel (13) is controlled depending on the concentration of gaseous reaction products (2) carried off by the transport gas (G).
